(19) United States
(12) Patent Application Publication
(10) Pub. No.: US 2025/0124907 A1
(43) Pub. Date: Apr. 17, 2025

(54) Electric Guitar Quick Exchange Pickup Assembly

(71) Applicant: Michael D Todnem, Tucson, AZ (US)

(72) Inventor: Michael D Todnem, Tucson, AZ (US)

(21) Appl. No.: 18/779,037

(22) Filed: Jul. 21, 2024

Related U.S. Application Data
(60) Provisional application No. 63/544,173, filed on Oct. 14, 2023.

(51) Int. Cl. G10H 3/18; G10D 1/08; G10H 1/14; G10H 1/46

(52) U.S. Cl. CPC G10H 3/181; G10D 1/085; G10H 1/14; G10H 1/46; G10H 3/182; G10H 2220/461

(57) ABSTRACT

An Electric Guitar Quick Exchange Pickup Assembly facilitates a quick exchange of electric guitar pickups. The assembly comprises a chassis body and one or more inserts. The chassis body allows for a rapid and intuitive process for guitarists to effortlessly swap out pickups within seconds by seating the pickup-housed insert into the chassis body without the need for any additional adjustments, ensuring reliable electrical connections and providing a wide range of tonal possibilities. The Electric Guitar Quick Exchange Pickup Assembly may further comprise a pickguard assembly. The chassis body comprises one or more cavities, a wiring harness assembly, and a wiring attachment block.

### CROSS-REFERENCE TO RELATED APPLICATIONS

This application claims the priority benefit of U.S. Provisional Patent Application Ser. No. 63/544,173 filed Oct. 14, 2023.

### STATEMENT REGARDING FEDERALLY SPONSORED R & D

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM

Not Applicable

### STATEMENT REGARDING PRIOR DISCLOSURES BY AN INVENTOR OR JOINT INVENTOR

Not Applicable

### BRIEF DESCRIPTION OF THE INVENTION

The present disclosure relates to an Electric Guitar Quick Exchange Pickup Assembly (150) that facilitates a quick exchange of electric guitar pickups (130). A chassis body (200) allows for a rapid and intuitive process for guitarists to effortlessly swap out pickups (130) within seconds by seating an insert (300) that houses pickups (130) into the chassis body (200) without the need for any additional adjustments, ensuring reliable electrical connections and providing a wide range of tonal possibilities.

The Electric Guitar Quick Exchange Pickup Assembly (150) comprises a chassis body (200) and one or more inserts (300). The Electric Guitar Quick Exchange Pickup Assembly (150) may further comprise a pickguard assembly (400). The chassis body (200) comprises one or more cavities (210), a wiring harness assembly (270), and a wiring attachment block (280).

FIG. 24 is an isometric top view of a chassis body (200) seated into the guitar body (110), showing three inserts (300) in various insertion states onto their corresponding cavities (210). FIG. 25 is a top view of an electric guitar (100) where a chassis body (200) is seated into the guitar body (110), showing three inserts (300) in various insertion states onto their corresponding cavities (210), where each insert (300) houses a pickup (130). FIG. 26 is an isometric view of an electric guitar (100), where a chassis body (200) is seated into the guitar body (110), showing three inserts (300) in various insertion states onto their corresponding cavities (210), where each insert (300) houses a pickup (130). FIG. 19 is a top view of the chassis body (200), showing three cavities (210) and a wiring attachment block (280).

### BRIEF DESCRIPTION OF THE SEVERAL VIEWS OF THE DRAWING

FIG. 1 shows FIG. 10 of Prior Art U.S. Pat. No. 6,111,184A;

FIG. 2 shows FIG. 2 of Prior Art U.S. Pat. No. 6,911,590B2;

FIG. 3 shows FIG. 1 and FIG. 3 of Prior Art US20210035544A1;

FIG. 4 shows FIG. 8 of Prior Art U.S. Pat. No. 6,253,654B1;

FIG. 5 shows the innards of the guitar body (110), which includes the chambers (115) that house the pickups (130);

FIG. 6 is an expanded view of FIG. 5 showing the chambers (115) existing in situ for Stratocastor style guitars that house the pickups (130);

FIG. 7 shows a guitar body cavity (120) that accommodates the Electric Guitar Quick Exchange Pickup Assembly (150) within the guitar body (110). The guitar body cavity (120) comprises a chassis body cavity portion (122) and a pickguard cavity portion (124);

FIG. 8 is an expanded view of FIG. 7, showing a guitar body cavity (120) that accommodates the Electric Guitar Quick Exchange Pickup Assembly (150) within the guitar body (110) comprised of a chassis body cavity portion (122) and a pickguard cavity portion (124);

FIG. 9 shows the chassis body (200) seated into the chassis body cavity portion (122);

FIG. 10 is an expanded view of FIG. 9 showing the chassis body (200) seated into the chassis body cavity portion (122);

FIG. 11 is top view of the Electric Guitar Quick Exchange Pickup Assembly (150), comprising a chassis body (200), three inserts (300), and a pickguard assembly (400);

FIG. 12 is an isometric view of an insert (300), with its top piece (310) and bottom piece (320) snapped together;

FIG. 13 is an isometric view of the bottom piece (320) of an insert (300);

FIG. 14 is a bottom view of the top piece (310) of an insert (300);

FIG. 15 is a left side view of an insert (300), showing the top piece (310) and the bottom piece (320) snapped to house a humbucker pickup (138);

FIG. 16 is a back view of an insert (300), showing the location of a plurality of pin connectors (380), where the plurality of pin connectors (380) is in a four position spring piston connector (382) configuration;

FIG. 17 is a top view of an insert (300), showing an insert (300) in a Humbucker configuration—two pickups (130) and four wire connectors (390), in a four position configuration;

FIG. 18 is a front view of an insert (300), showing four wire connectors (390) attached to the bottom piece (320) of the insert (300);

FIG. 19 is a top view of the chassis body (200), showing the top of the chassis body (200), where the wiring attachment block (280) is oriented 180 degrees from the top of the chassis body (200).

FIG. 20 is a back view of the chassis body (200), showing the wiring attachment block (280) attached to the wiring harness assembly (270);

FIG. 21 is a top view of the chassis body (200), showing the wiring attachment block (280), the wiring attachment block (280) comprising of a plurality of wire connectors (281), where each wire connector (281) is comprised of a spring loaded push button (282) and corresponding wire contact interface (284);

FIG. 22 is an isomeric top view of the chassis body (200), showing the electronic targets (234) attached to the back side panels (230) defined by corresponding cavities (210);

FIG. 23 is an isomeric top view of the chassis body (200), showing the front side panel (220) at an angle Q (theta) relative to the back side panel (230);

FIG. 24 is an isometric top view of a chassis body (200) seated into the guitar body (110), showing three inserts (300) in various insertion states onto their corresponding cavities (210);

FIG. 25 is a top view of an electric guitar (100) where a chassis body (200) is seated into the guitar body (110), showing three inserts (300) in various insertion states onto their corresponding cavities (210), where each insert (300) houses a pickup (130);

FIG. 26 is an isometric view of an electric guitar (100) where a chassis body (200) is seated into the guitar body (110), showing three inserts (300) in various insertion states onto their corresponding cavities (210), where each insert (300) houses a pickup (130).

### BACKGROUND OF INVENTION

### 1 Field of Invention

The present disclosure relates generally to stringed musical instruments. More particularly, the present disclosure relates to mechanical designs for electric guitars and electrical guitar components.

### 2 Description of Related Art

Electric guitars and basses, along with other applicable instruments, utilize magnetic pickups to capture the vibrations of the strings for amplification. These pickups typically comprise a magnetic core or cores wrapped with wire windings. As ferromagnetic strings vibrate within the magnetic field, they induce a corresponding voltage in the winding, a technology that has seen widespread use for many decades.

Among musicians, particularly guitarists, there is a deep awareness that the type and construction of a pickup greatly influence the resulting sound of the instrument. Guitarists meticulously choose pickups to achieve specific sonic characteristics, and the market offers a vast array of pickup options, numbering in the thousands.

However, selecting pickups presents several challenges. Firstly, they often come at a considerable cost, sometimes exceeding a hundred dollars each, and guitars typically feature two or three pickups. This financial constraint limits a guitarist's ability to experiment with different pickups, forcing them to stick within their budget and potentially leading to losses if unsatisfactory pickups need to be resold.

Additionally, pickups produce varied sounds depending on factors such as string type and condition, instrument shape and construction, wood type, ambient temperature and humidity, acoustic environment, and even the player's mindset during performance. Consequently, a pickup's sound recorded after installation in one instrument may differ significantly when installed in another instrument or played in a different setting, complicating pickup comparisons.

Another issue arises from the imprecise language used to describe pickup tones in trade publications and manufacturers' advertisements, employing terms like “bright,” “dark,” or “woody.” As a result, pickup reviews in trade publications offer limited assistance in the pickup selection process.

Furthermore, the installation process for pickups is time-consuming, requiring an hour or two to remove strings, dismantle parts of the instrument, solder in the new pickups, reassemble the instrument, and restring it. This lengthy process makes rapid A/B comparisons difficult and may obscure subtle differences between pickups due to the installation delay.

Changing pickups in electric guitars manufactured by major companies requires technical knowledge of electric wiring diagrams, soldering skills, and a significant amount of time. This process typically involves removing the pickguard assembly, desoldering the existing pickups, soldering the new pickups into place, and reassembling the guitar. The complexity of this process often discourages guitarists from experimenting with different pickups or modifying their instrument's sound.

Although there are existing solutions that claim to facilitate quicker pickup exchanges, they often involve purchasing cost prohibitive guitars specifically designed for rapid pickup swaps. This limits the choices available to guitarists who prefer to use their own familiar instruments, as familiarity with one's own guitar is paramount in many musical performances.

### 2.1 Prior Art

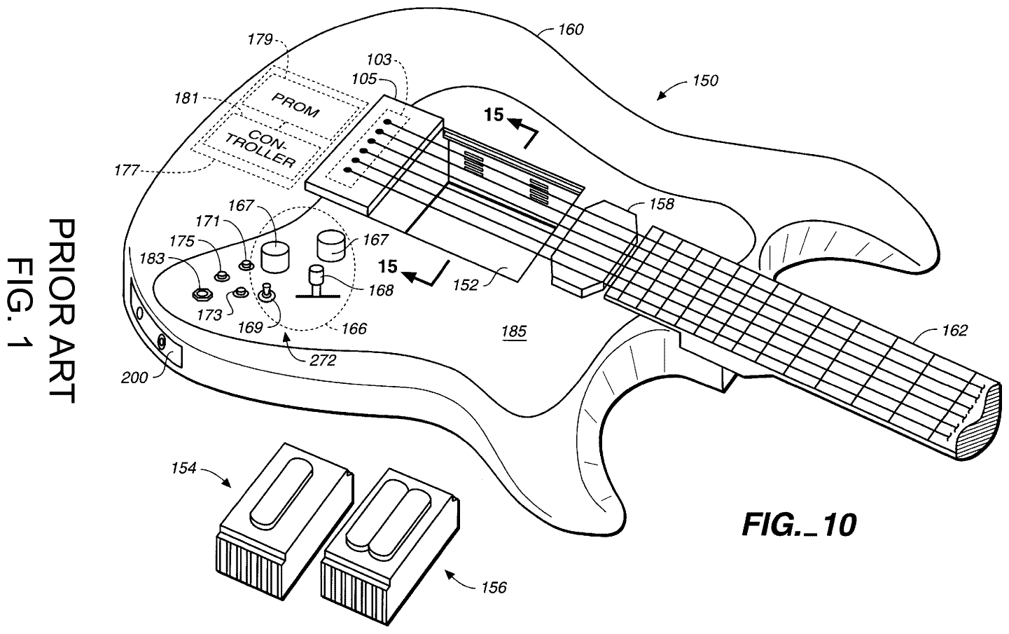

In U.S. Pat. No. 6,111,184A—Interchangeable pickup—electric stringed instrument and system for an electric stringed musical instrument, a generally rectangular shaped universal pickup cradle (50, 154 or 156) for an electric musical stringed instrument (20 or 150) allows a plurality of different pickups (50, 154, 156) to be interchangeably seated into the stringed musical instrument. In addition, there are one or more receptacle cavities (36, 38, 40, 152) in the stringed musical instrument (20, 150) so that any of the universal pickup cradles (50, 154, 156) may be placed within any of the receptacle cavities. The universal pickup cradles (50, 154, 156), in combination with a separate electronics module (177, 200), provide a flexible and upgradeable system for an electric stringed instrument. See FIG. 1. However, although the disclosure states that the universal pickup cradles are easily slid into place, the position of the guitar strings and the geometry of the receptacle cavity and the pickup cradles prevent such movement without having to disassemble the strings or at least having to physically awkwardly move the strings. Furthermore, there is no guidance to assist the sliding, making for more of an insertion movement. Furthermore, there is no easy manner to interchange electrical wire positioning that leads to the output/input module or the guitar manual control switches.

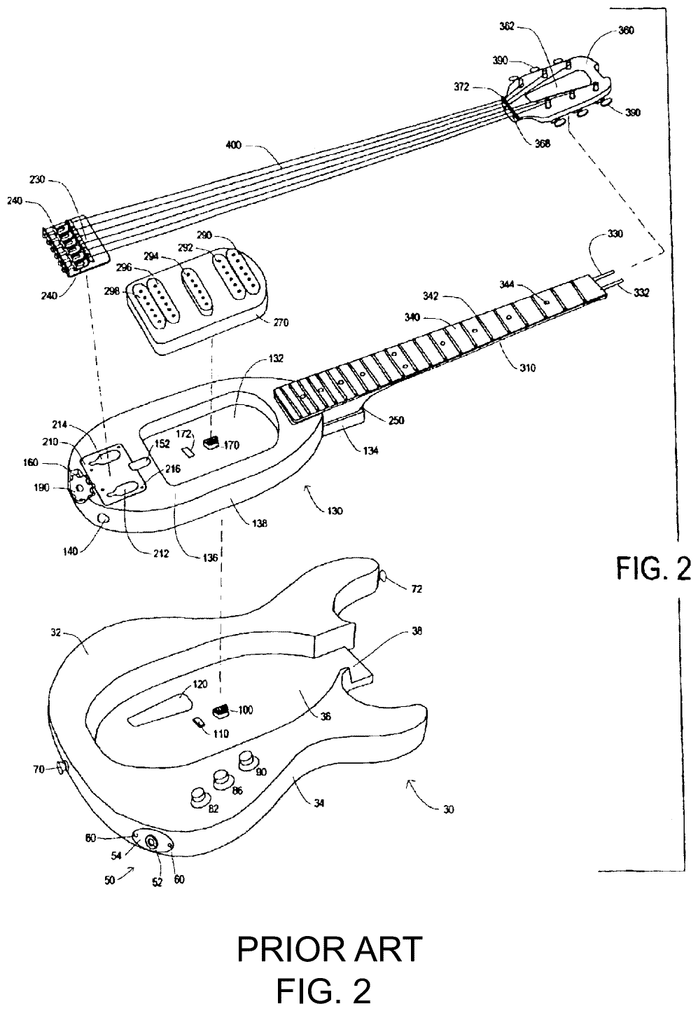

In U.S. Pat. No. 6,911,590B2—Interchangeable guitar, a guitar having a shell body and a main body—The main body and/or a portion of the main body is detachably connected to the shell body. A neck is connected to the main body and/or the shell body. A bridge is connected to the main body. The neck includes a headstock and a fret control that at least partially raises and/or lowers at least one fret on the neck. See FIG. 2. However, the position of the guitar strings and the geometry of the shell body (pickup box (270) and pickup box cavity) prevent an easy movement without having to disassemble the strings or at least having to physically awkwardly move the strings. Furthermore, there is no guidance to assist the movement of the pickup box into the pickup box cavity. Furthermore, there is no easy and quick manner to interchange electrical wire positioning that leads to the guitar controllers (80, 84, 88). Furthermore, there is no easy way to attach the wiring from the pickups (290, 292, 294, 296, 298) to the pickup box (270). The use of pickup flanges (300) to secure the pickup to the pickup box (270) is awkward and time consuming to implement.

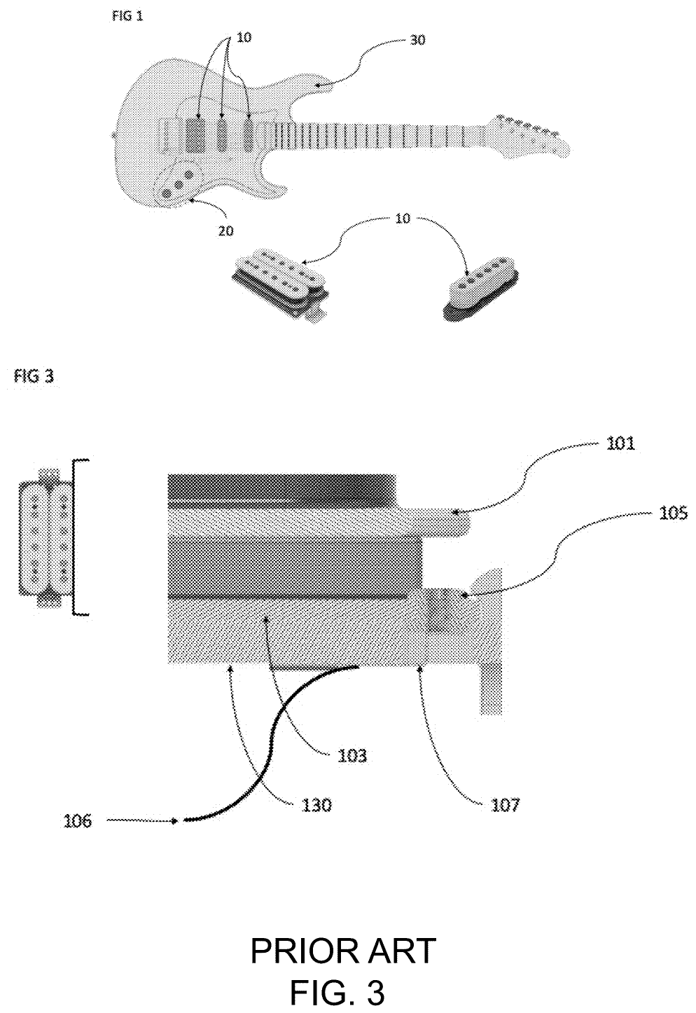

In US 20210035544A1—Interchangeable pickup system Issue—A docking system for an electromagnetic pickup of a musical instrument comprises an electromagnetic pickup mounting plate upon which the electromagnetic pickup is mounted and a body mounting plate. The electromagnetic pickup mounting plate includes a first electrical contact configured to be electrically connected to the electromagnetic pickup. The body mounting plate includes a second electrical contact configured to electrically connect to the first electrical contact of the electromagnetic pickup mounting plate and configured to be electrically coupled to external electronics for receiving electrical signals from the electromagnetic pickup and a mechanical detent configured to mechanically interface with the electromagnetic pickup mounting plate to detachably secure the electromagnetic pickup mounting plate to the body mounting plate. See FIG. 3. However, the position of the guitar strings and the geometry of the removable pickup assembly (100) and the mounting cavity prevent an easy movement without having to disassemble the strings or at least having to physically awkwardly move the strings. Furthermore, there is no guidance to assist the movement of the removable pickup assembly (100) into the mounting cavity. Furthermore, within the mounting cavity, there is no easy and quick manner to interchange electrical wire (106) positioning that leads to the electronics control system (200). Furthermore, the invention teaches the use of screws to mount the body mounting plate to the instrument (30). This is a not a quick or easy manner to remove and interchange pickup assemblies (100).

In U.S. Pat. No. 6,253,654B1—Electric stringed instrument with interchangeable pickup assemblies which connect to electronic components fixed within the guitar body—An electric stringed instrument, e.g. an electric guitar, featuring a body having a rectangular shaped, throughthe-body cutout between the neck and bridge, and having a connector in a portion of the cutout. Pins on the connector are wired to electronic control components that are permanently fixed in the body. A rapidly interchangeable pickup assembly containing one or more pickups, in any combination of single and dual coils, fits into the cutout. Many and varied pickup assemblies, each with different characteristics of tone, strength, and frequency range emphasis can be interchangeably installed into the cutout. A connector on the pickup assembly mates with the body connector, thus accomplishing an electrical connection between the pickups in the assembly and the control electronics. The pickup assembly, having no control electronics on it, is light, compact, and easily maneuvered with one hand into and out of the cutout from the rear of the instrument. Once securely installed, the pickup assembly is in the optimum position to respond to string vibration. This vibration is converted into an electrical signal, sent and processed through the control electronics to an external unit for amplification. See FIG. 4. However, this arrangement does not allow the interchange of a single pickup within a plurality of pickups (40, 42, 44, 46, 48), as the invention teaches the replacement of the entirety of the interchangeable pickup assembly (56). Hence, this device limits the diversity of pickup arrangements that an electric guitar might have. Furthermore, the pickups (40, 42, 44, 46, 48) within the interchangeable pickup assembly (56) are hard wired to the connection (30),

### 2.2 Prior Art Summary

Hence there is a need for an assembly that will facilitate a quick exchange of electric guitar pickups, allowing for a rapid and intuitive process for guitarists to effortlessly swap out pickups within seconds by seating the appropriate loaded pickup insert into the chassis body, without the need for any additional adjustments whereby the assembly's design ensures reliable electrical connections and provides a wide range of tonal possibilities.

### DEFINITIONS “to seat” to fit into a cavity

### DETAILED DESCRIPTION OF THE INVENTION

The present disclosure relates to an Electric Guitar Quick Exchange Pickup Assembly (150) that facilitates a quick exchange of electric guitar pickups (130). A chassis body (200) allows for a rapid and intuitive process for guitarists to effortlessly swap out pickups (130) within seconds by seating an insert (300) that houses pickups (130) into the chassis body (200) without the need for any additional adjustments, ensuring reliable electrical connections and providing a wide range of tonal possibilities.

The Electric Guitar Quick Exchange Pickup Assembly (150) comprises a chassis body (200) and one or more inserts (300). The Electric Guitar Quick Exchange Pickup Assembly (150) may further comprise a pickguard assembly (400). The chassis body (200) comprises one or more cavities (210), a wiring harness assembly (270), and a wiring attachment block (280).

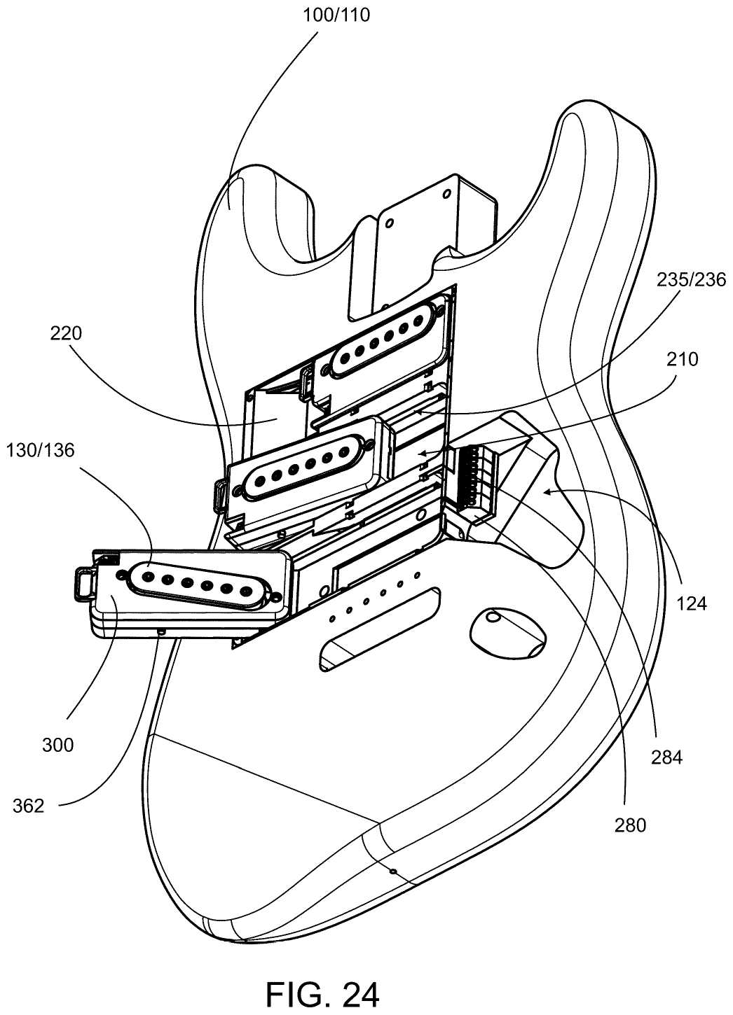

FIG. 24 is an isometric view of Electric Guitar Quick Exchange Pickup Assembly (150), with a chassis body (200) seated into the guitar body (110), showing three inserts (300) in various insertion states onto their corresponding cavities (210).

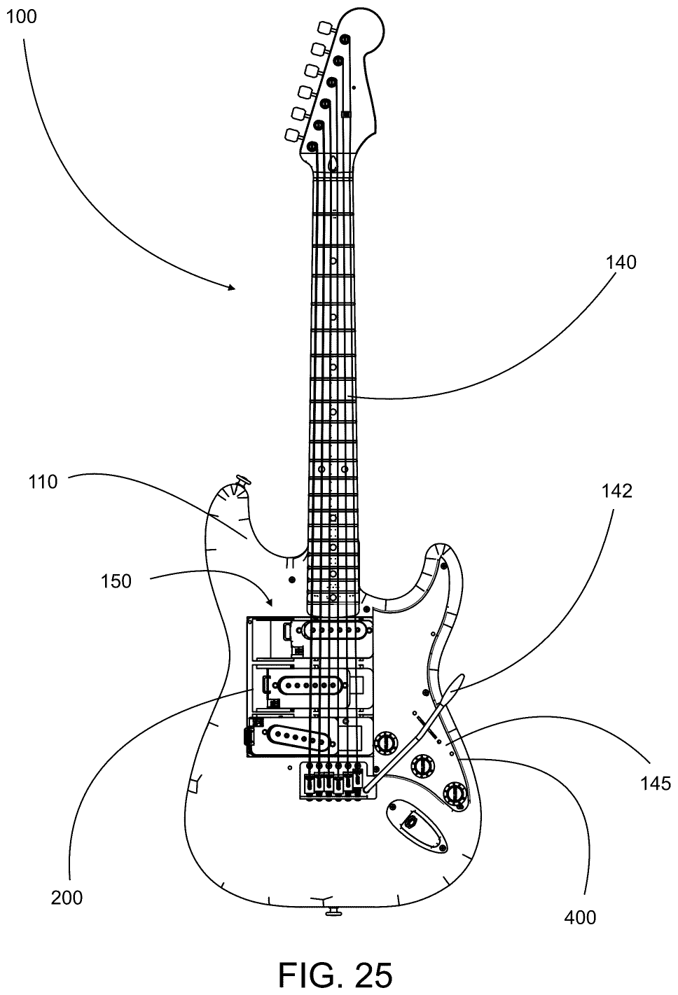

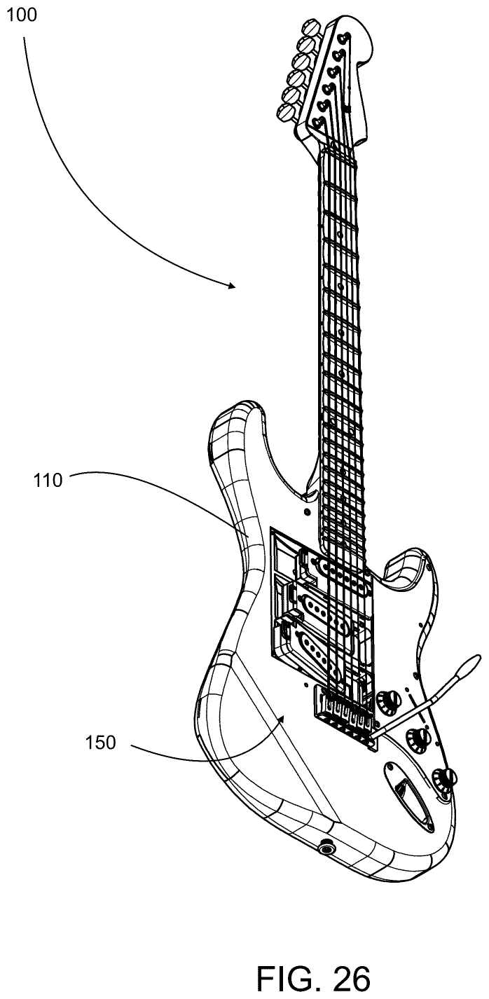

FIG. 25 is a top view of an electric guitar (100) where a chassis body (200) is seated into the guitar body (110), showing three inserts (300) in various insertion states onto their corresponding cavities (210), where each insert (300) houses a pickup (130). FIG. 26 is an isometric view of an electric guitar (100) where a chassis body (200) is seated into the guitar body (110), showing three inserts (300) in various insertion states onto their corresponding cavities (210), where each insert (300) houses a pickup (130).

Having a variety of preloaded inserts (300) containing different pickups (130) of the user's choice allows for interchangeability whereby the user can effortlessly choose, seat, and lock these pickups (130) in place and hear the changes instantly. For good measure, the one or more inserts (300) could be color-coded to identify different tonal characteristics of each insert (i.e. Country, rock, classical or various rock tones). The primary objective of the Electric Guitar Quick Exchange Pickup Assembly (150) is to make the process extremely intuitive for the user to replicate and/or discover tonal possibilities. Ultimately, the Electric Guitar Quick Exchange Pickup Assembly (150) allows guitarists of all levels to learn how to modify their instruments to their preferences. The Electric Guitar Quick Exchange Pickup Assembly (150) provides guitarists with immediate tonal variations and a versatile platform for customization, ultimately enhancing their musical expression.

### 1 Electric Guitar (100) Preparation

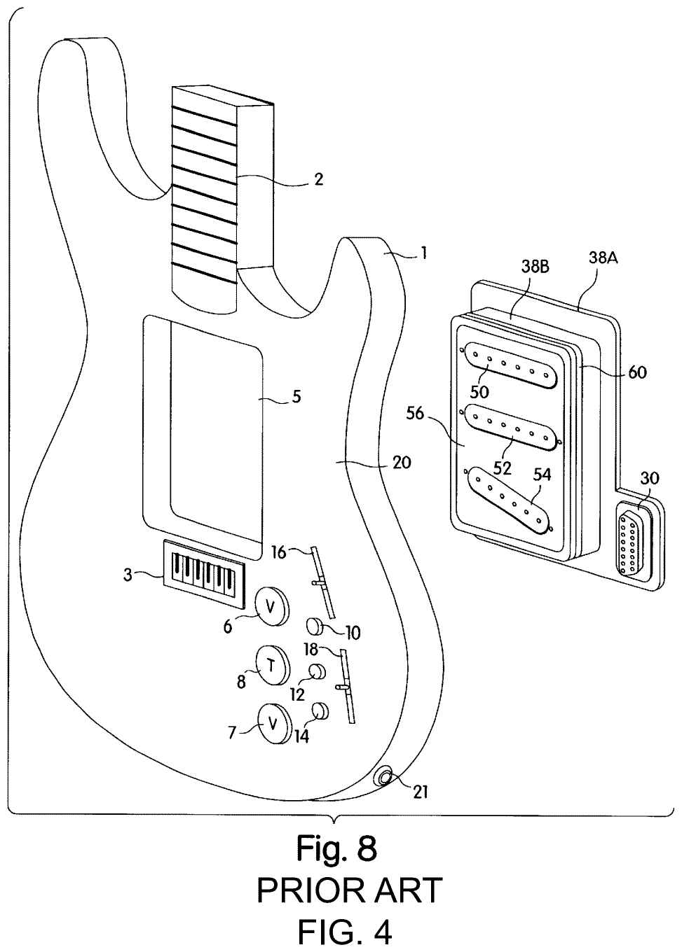

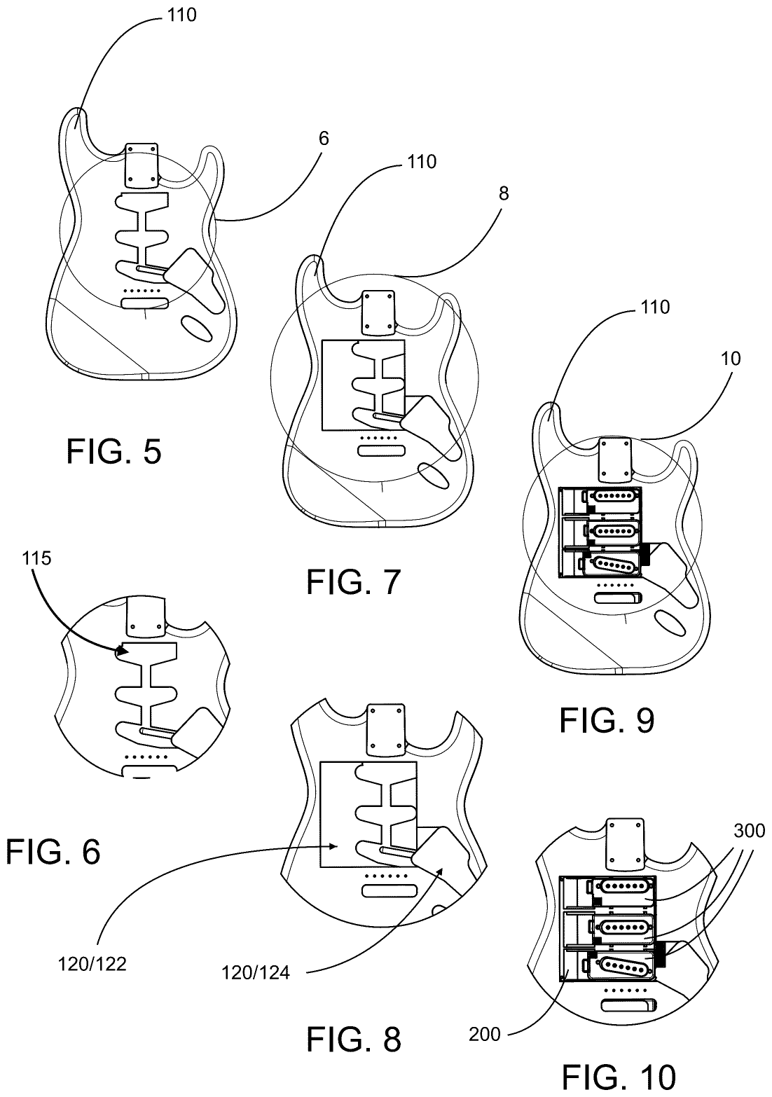

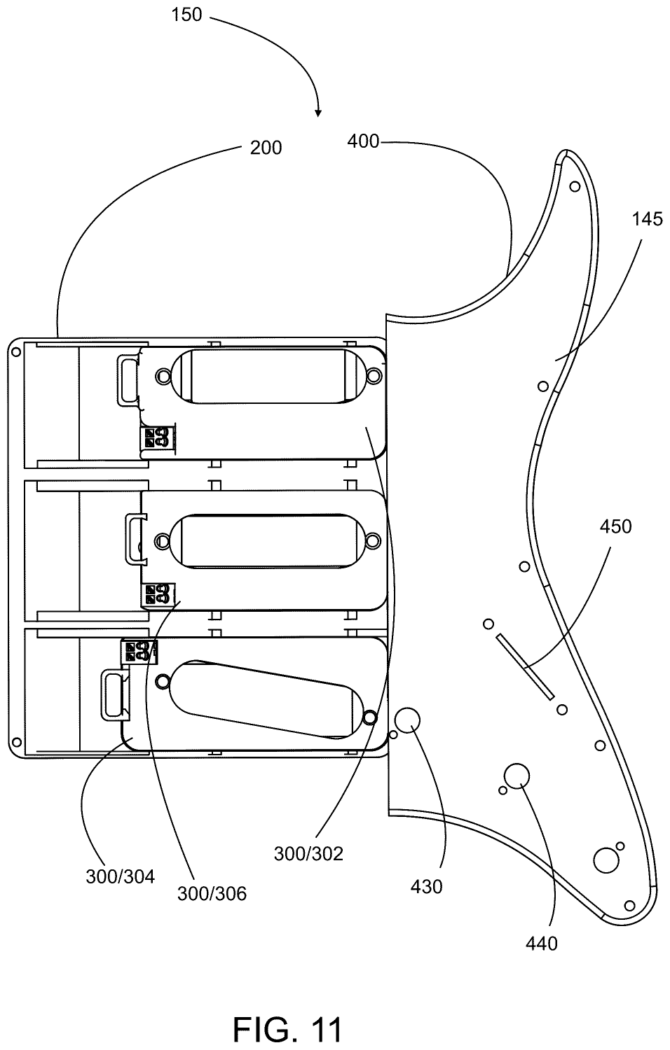

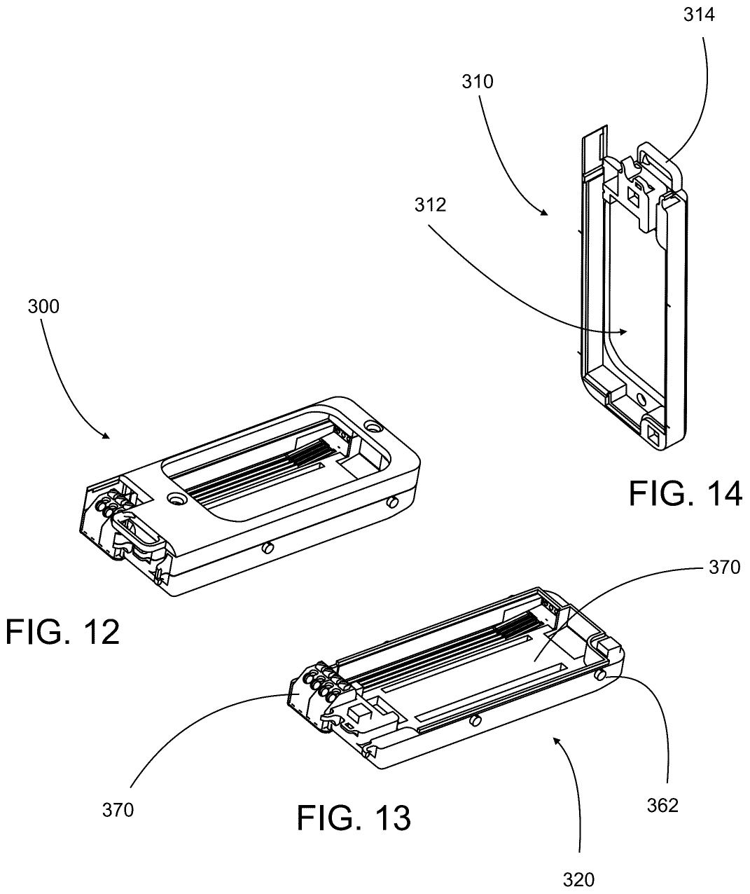

To incorporate the Electric Guitar Quick Exchange Pickup Assembly (150) into an electric guitar (100), the electric guitar (100) is disassembled, including guitar strings (140), pickups (130), and pickguard (145). This removal exposes the innards of the guitar body (110), which includes chambers (115) that house the pickups (130). FIG. 5 shows the chambers (115) existing in situ for Stratocastor style guitars that house the pickups (130). FIG. 6 is an expanded view of FIG. 5 showing the chambers (115) that house the pickups (130).

A guitar body cavity (120) is carved out within the front side of the guitar body (110) so that there is enough space to house the chassis body (200) and the pickguard assembly (400). The guitar body cavity (120) comprises a chassis body cavity portion (122) and a pickguard cavity portion (124). FIG. 7 shows a guitar body cavity (120) that accommodates the Electric Guitar Quick Exchange Pickup Assembly (150) within the guitar body (110). The guitar body cavity (120) comprises a chassis body cavity portion (122) and a pickguard cavity portion (124). FIG. 8 is an expanded view of FIG. 7, showing a guitar body cavity (120) within the guitar body (110), comprising a chassis body cavity portion (122) and a pickguard cavity portion (124).

Once the guitar body cavity (120) is carved out, the chassis body (200) is seated into the chassis body cavity portion (122) and the pickguard assembly (400) is seated into the pickguard cavity portion (124). FIG. 9 shows the chassis body (200) seated into the chassis body cavity portion (122). FIG. 10 is an expanded view of FIG. 9 showing the chassis body (200) seated into the chassis body cavity portion (122).

The guitar body cavity (120) is located within the guitar body (110) so that the seated chassis body (200) and the seated pickguard assembly (400) do not interfere with the existing tremolo apparatus (142) within the guitar body (110). FIG. 25 shows a top view of an electric guitar (100) where a chassis body (200) is seated into the guitar body (110), showing the chassis body (200) above the existing tremolo apparatus (142) within the guitar body (110).

The guitar body cavity (120) is located within the guitar body (110) so that the pickups (130) housed within the fully seated inserts (300) lie below the guitar strings (140) of the electric guitar (100). This positioning allows for the optimal sensing by the pickups (130).

The guitar body cavity (120) is located within the guitar body (110) so that the handles (314) of the inserts (300) are located to the side and away from the guitar strings (140) when the inserts (300) are seated into the corresponding cavities (210) of the chassis body (200). This location configuration allows the inserts (300) to be seated and unseated without having to touch the guitar strings (140) as a user would engage the handle (314) of the inserts (300) to seat and unseat the inserts (300). This location configuration prevents unintended contact with the guitar strings (140) and its corresponding emitted sounds.

### 2 Chassis Body (200)

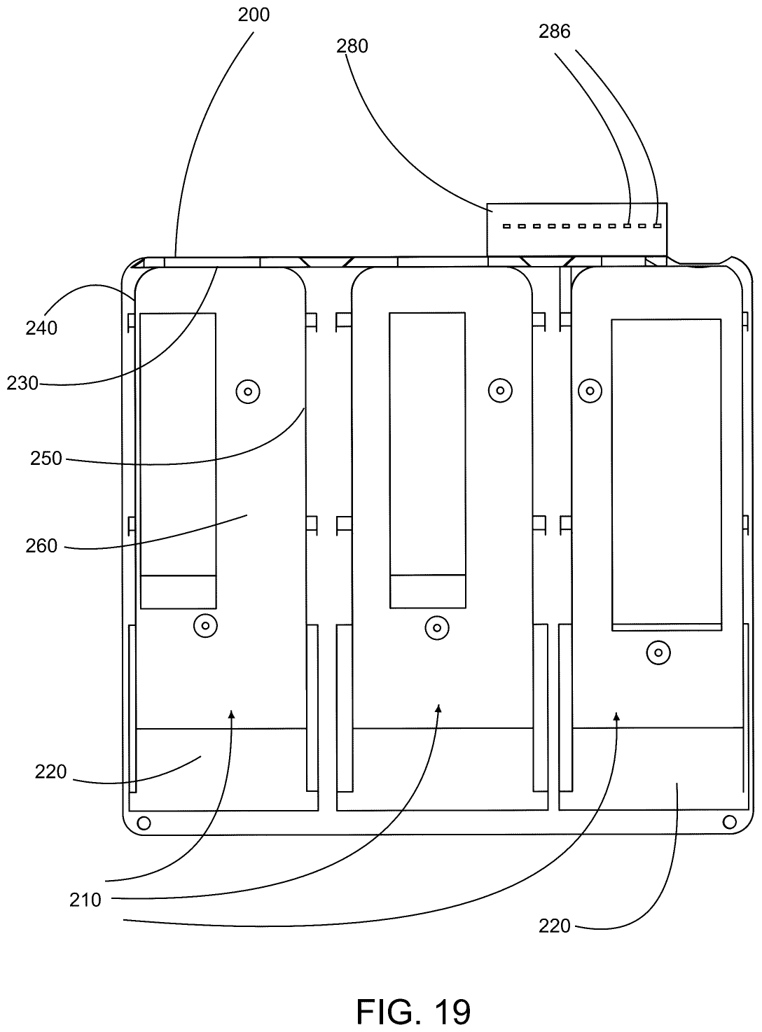

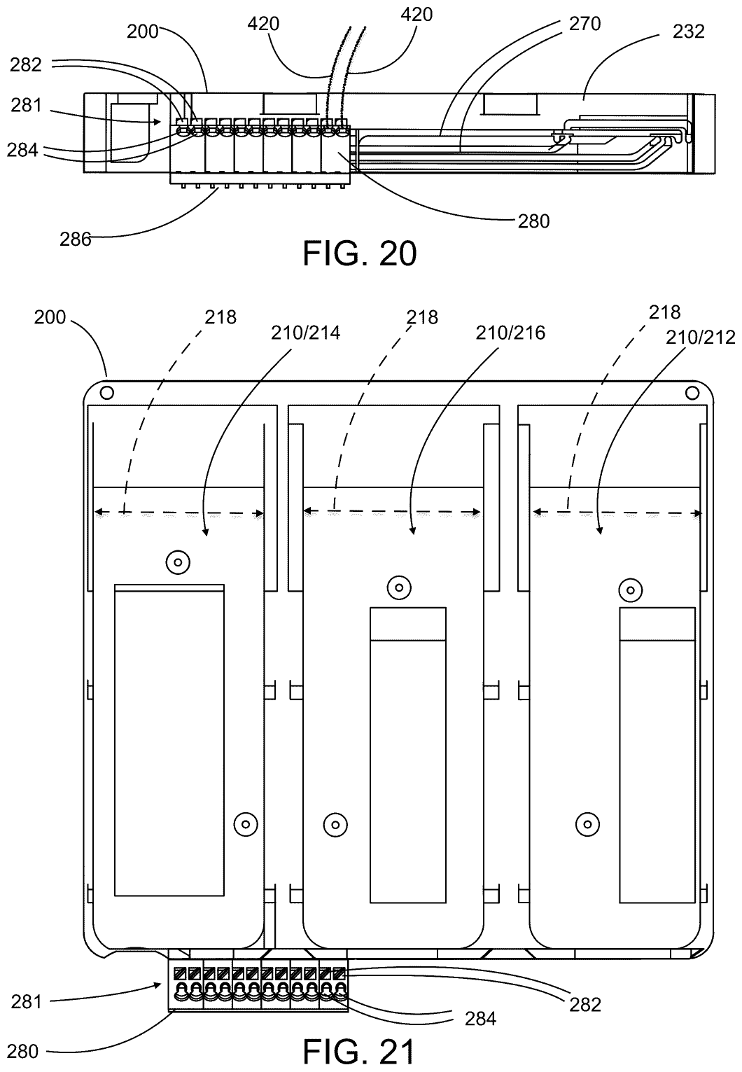

The chassis body (200) comprises one or more cavities (210), a wiring harness assembly (270), and a wiring attachment block (280). FIG. 19 is a top view of the chassis body (200), showing three cavities (210) and a wiring attachment block (280).

The chassis body (200) houses inserts (300) and provides a convenient manner to connect the wiring attachment block (280) to the rest of the guitar elements. The chassis body (200) is designed to accommodate the inserts (300) and to secure the wiring (420) of the pickguard assembly (400) and to provide a stable foundation for the guitar pickups (130).

The chassis body (200) is oriented so that inserts (300) are seated into the corresponding cavities (210) perpendicular to the orientation of the guitar strings (140). FIG. 19, FIG. 25, FIG. 26 show inserts (300) being seated into cavities (210) perpendicular to the orientation of the guitar strings (140).

### 2.1 Cavity (210)

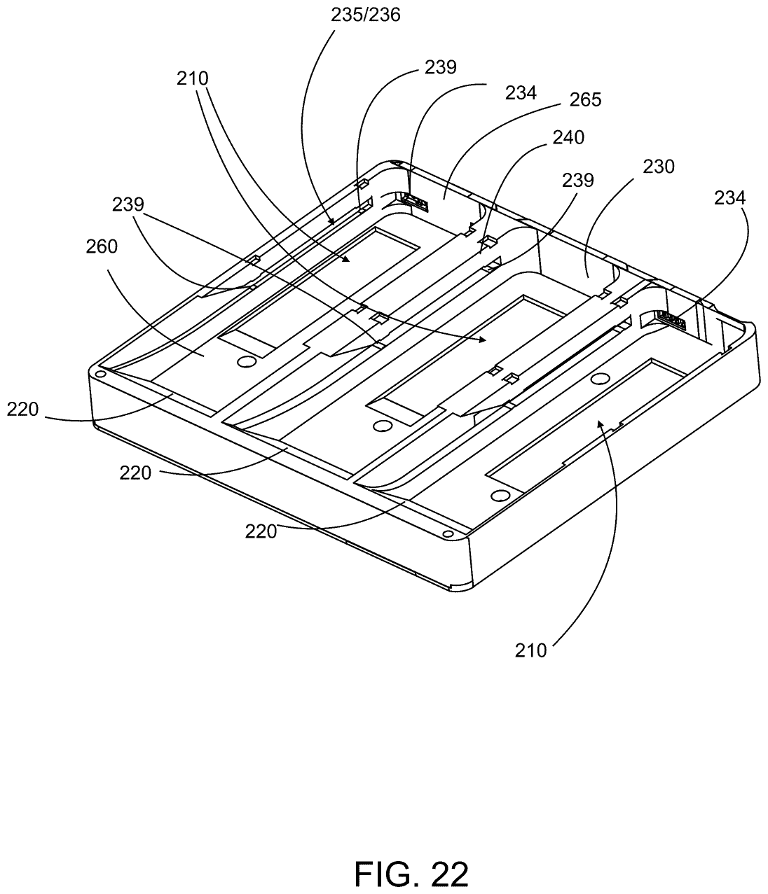

Each cavity (210) within the chassis body (200) is sized to house a corresponding insert (300). Within the chassis body (200), each cavity (210) defines a front side panel (220), a back side panel (230), a left side panel (240), a right side panel (250), and a bottom panel (260). FIG. 22 is an isomeric top view of the chassis body (200), showing three cavities (210), each cavity (210) having a front side panel (220), a back side panel (230), a left side panel (240), a right side panel (250) and a bottom panel (260).

In a first embodiment, all of the widths (218) for each cavity (210) are substantially the same, in order to provide a standardized space to seat the inserts (300). The corresponding width (308) of each insert (300) is substantially the same. The width (218) of each cavity (210) is sized to accommodate the width (308) of the corresponding insert (300).

In a second embodiment, the width (218) of at least one of the cavities (210) differs from the width (218) of the other cavities (210). Adjusting the width (218) of at least one of the cavities (210) allows for the reduction of electronic interference between inserts (300), as electromagnetic fields change by the reciprocal of distance squared. The width (308) of the corresponding inserts (300) would be sized accordingly. For example, in a three cavity (210) configuration, the chassis body (200) comprises three cavities (210)—a first side cavity (212), a second side cavity (214), and a middle cavity (216); the Electric Guitar Quick Exchange Pickup Assembly (150) comprises three inserts: a first side insert (302), a second side insert (304), and a middle insert (306). The width (308) of the middle insert (306)—a third width—is sized differently, either smaller or larger than the width (308) of the first side insert (302)—a first width—and the width (308) of the second side insert (304)—a second width. Correspondingly, the width (218) of the middle cavity (216)—a third width—is sized differently, either smaller or larger than the width (218) of the first side cavity (212)—a first width—and the width (218) of the second side cavity (214)—a second width. FIG. 21 shows a chassis body (200) with three cavities (210), where the width (218) of the middle cavity (216) is larger than the width (218) of the first side cavity (212) and the second side cavity (214).

The left side panel (240) and the right side panel (250) lie substantially parallel to each other. The back side panel (230) lies perpendicular to both the left side panel (240) and the right side panel (250).

Both the left side panel (240) and the right side panel (250) comprise a means to slide an insert (235). The means to slide an insert (235) is a structure that guides the inserts (300) into the corresponding cavity (210) so that the inserts (300) seat into the cavities (210). The structure creates a channel (236) that constrains the movement of the left slide guides (352) and the right slide guides (362) of an insert (300). The channel (236) maybe created by sets of rails (238) (not shown) that protrude from both the left side panel (240) and the right side panel (250). Alternatively, the channel (236) maybe created by recessing a channel (236) into the left side panel (240) and recessing a channel (236) into the right side panel (250). FIG. 24 shows an insert (300) being guided into a cavity (210) by a means to slide an insert (235), where a channel (236) is recessed into the left side panel (240). FIG. 22 shows a means to slide an insert (235), where a channel (236) is recessed into the left side panel (240).

The means to slide an insert (235) may also comprise one or more protrusions (239), which partially block the channel (236). The protrusions (239) act as a friction lock. The number of protrusions (239) for each means to slide an insert (235) correspond to the number of slide guides (352) on each side of the insert (235). For example, if an insert (300) has two slide guides (352, 362) in both the left side (350) and the right side (360) of the bottom piece (320) of the insert (300), there would be two protrusions (239) in each means to slide an insert (235). When an insert (300) is seated into the corresponding cavity (210), the slide guides (352, 362) are pushed past the protrusions (239), which partially block the channel (236). The protrusions (239) prevent the slide guides (352, 362) from sliding back out past the protrusions (239); the means to slide an insert (235) prevents the movement of the insert (300) by the physical blocking and the friction that the protrusions (239) create. The protrusions (239) act as a friction lock.

The protrusions are preferably integral to the structure that creates the channel (236).

The use of a certain amount of pulling force upon the insert (300) when sliding out the insert (300) from a cavity (210) serves to overcome the physical blocking and the friction that the protrusions (239) create.

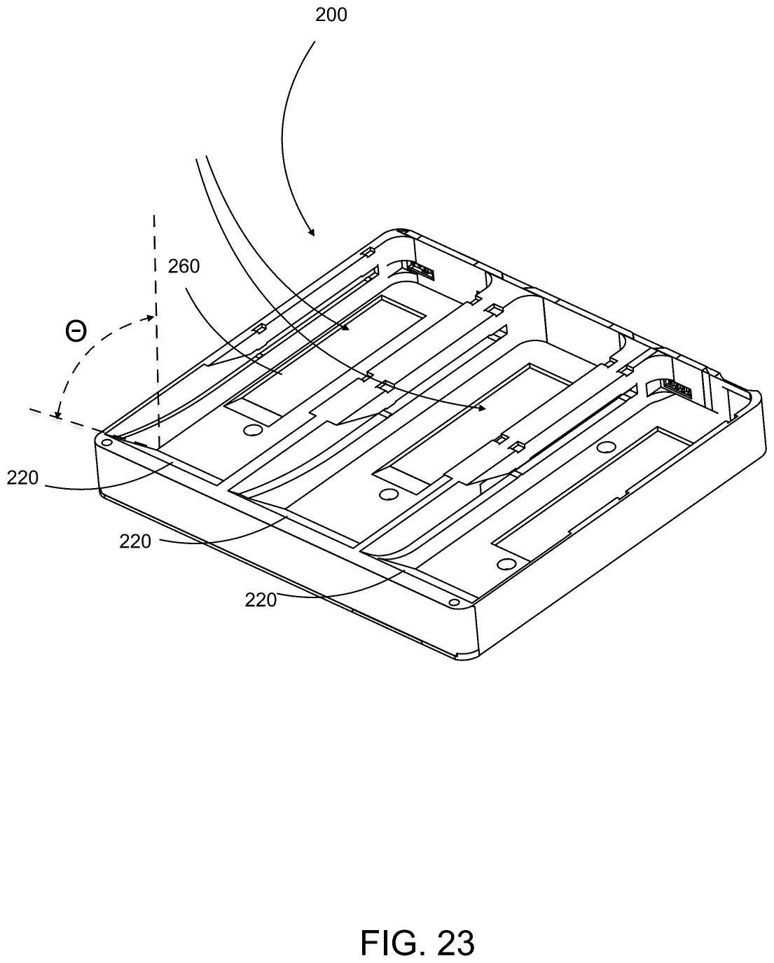

The front side panel (220) lies at an angle Θ (theta) relative to the back side panel (230). The angle Θ provides a gradually increasing clearance space for an insert (300) when the insert (300) is seated into the corresponding cavity (210). This gradually increasing clearance space allows the insert (300) to be easily guided and seated into the corresponding cavity (210) without having to physically move the guitar strings (140). This provides a more efficient manner to seat the insert (300) into the corresponding cavity (210). FIG. 23 is an isomeric top view of the chassis body (200), showing the front side panel (220) at an angle Θ (theta) relative to the back side panel (230).

Each back side panel (230) comprises an electronic target (234). The back side panel (230) may further comprise a circuit board (232). The electronic targets (234) provide an electrical connection between the chassis body (200) and each insert (300). The electronic targets (234) of the back side panel (230) are located so that they are operatively connected to the plurality of pin connectors (380) of the bottom piece (320) of the insert (300) when the insert (300) is seated within the corresponding cavity (210).

The angled side front side panel (220) of the cavity (210) interacts with the angled front side of the corresponding insert (300), allowing the insert (300) to be easily guided and seated into the corresponding cavity (210) without having to physically move the guitar strings (140).

The back side panels (230) maybe formed as an integral block (265); the integral block (265) is removable from the rest of the chassis body (200). This allows the integral block (265) to be manufactured separately from the rest of the chassis body (200). Having the integral block (265) be manufactured separately allows for easier integration of the wiring harness assembly (270) and the wiring attachment block (280) to the integral block (265). FIG. 22 is an isomeric top view of the chassis body (200), showing the back side panels (230) manufactured as an integral block (265).

Having the back side panels (230) formed as an integral block (265) allows for the wiring harness assembly (270), the wiring attachment block (280) and the electronic targets (234) to be attached to integral block (265). When a circuit board (232) is present, the allows the wiring harness assembly (270), the wiring attachment block (280) and the electronic targets (234) to be attached to the circuit board (232) and the circuit board (232) to be attached to the integral block (265).

### 2.2 Wiring Harness Assembly (270) and Wiring Attachment Block (280)

The wiring harness assembly (270) operatively connects the electronic targets (234) of the back side panels (230) of the chassis body (200) to the wiring attachment block (280). The wiring harness assembly (270) provides an electrical connection between the electronic targets (234) of the back side panel (230) to the wiring attachment block (280). The wiring harness assembly (270) ensures reliable electrical connections and efficient signal transfer between the pickups (130) and the guitar's electronics.

The wiring attachment block (280) provides for standardized connection points for the wiring (420) of the pickguard assembly (400) to the chassis body (200). The wiring attachment block (280) ensures stability and proper positioning of the wiring (420) of the pickguard assembly (400). The wiring attachment block (280) provides a connection between the wiring harness assembly (270) and the wiring (420) of the pickguard assembly (400). The wiring attachment block (280) comprises a plurality of wire connectors (281). The wiring (420) of the pickguard assembly (400) is engaged to the wire connectors (281) to ensure electrical conductivity between the pickguard assembly (400) to the chassis body (200). Each wire connector (281) may comprise a wire contact interface (284) and a spring loaded push button (282). To release or to introduce wiring (420) of the pickguard assembly (400) into the wire contact interface (284), the corresponding spring loaded push button (282) is engaged. The wiring (420) of pickguard assembly (400) can be easily removed from the wiring attachment block (280), allowing the wiring (420) of pickguard assembly (400) to be interchangeable.

The wiring attachment block (280) provides up to four wire connectors (281) per insert (300). This allows for each insert (300) to house either single coil pickups (136) or Humbucker pickups (138) since single coil pickups (136) have two wires and Humbucker pickups (138) have four wires. For example, in a three insert (300) configuration, the wiring attachment block (280) will have up to twelve (12) wire connectors (281).

The wiring attachment block (280) may be attached to the chassis body (200). The wiring attachment block (280) be solely attached to the wiring harness assembly (270), allowing for 360 degree rotation of the wiring attachment block (280), allowing for greater flexibility in attaching wiring (420) of the pickguard assembly (400) to the wiring attachment block (280).

When a circuit board (232) is utilized, the wiring attachment block (280), the wiring harness assembly (270) and the electronic targets (234) are attached to the circuit board (232).

### 3 Inserts (300)

An insert (300) houses one or more pickups (130). Pickup sensors (132) within a pickup (130) detect the movement of guitar strings (140) and produce electrical signals that are translated into sound signals. Pickup wires (134) attached to the pickup (130) allow for a connection to the insert (300). These inserts (300) are configured to slide into corresponding cavities (210) and be seated within the chassis body (200). The inserts (300) are seamlessly seated into the chassis body (200), providing a secure and easily interchangeable setup. The inserts (300) slide into position, locking into the correct position without requiring any adjustments to the guitar strings (140), the guitar body (110), or any other portion of the electric guitar (100). This quick maneuver can be completed in a matter of seconds, resulting in an immediate tonal change. Locked in the correct position, it ensures proper alignment and optimal performance without requiring any adjustments to the strings or the electric guitar (100).

An insert (300) may house one pickup (130)—a single coil pickup (136). An insert (300) may house two pickups (130)—a Humbucker pickup (138). The size of an insert (300) for both the single coil pickup (136) and the Humbucker pickup (138) are the same.

Because the size of each cavity (210) is preferably the same, this design allows for a multitude of pickup configurations. In a chassis body (200) with three cavities (210), there are eight possible insert configurations: SSS SSH SHS SHH HSS HSH HHS HHH (S=Single Coil Insert; H=Humbucker Insert). This provides flexibility in tone customization.

An insert (300) allows for pickup height adjustments. Each insert (300) comprises a top piece (310) and a bottom piece (320). The top piece (310) and the bottom piece (320) snap fit together to enable the exchange and securing of pickups (130) within the insert (300).

The top piece (310) comprises a pickup aperture (312), a handle (314), and a front side (316). The pickup aperture (312) provides access to the pickup (130) and the pickup sensors (132), allowing physical and electromagnetic interaction between the guitar strings (140) of the electric guitar (100) and the pickup sensors (132). The handle (314) allows for the movement of the insert (300) in and out of the corresponding cavity (210). The handle (314) is located on the front side (316) of the top piece (310).

The bottom piece (320) comprises a front side (330), a back side (340), a left side (350), a right side (360), a bottom side (370), a plurality of wire connectors (390), and a plurality of pin connectors (380). The bottom piece (320) houses the one or more pickups (130). When the insert (300) houses one pickup (130), one pair of wire connectors (390) are used for the pickup (130)). A pair of wire connectors (390) is also referred as a two position wire connector (392) (not shown). The two pickup wires (134) connect to the pair of wire connectors (390). When the insert (300) houses two pickups (130), four wire connectors (390) are used for the pickups (130). Four wire connectors (390) are also referred as a four position wire connector (394). The two sets of two pickup wires (134) connect to the corresponding wire connectors (390).

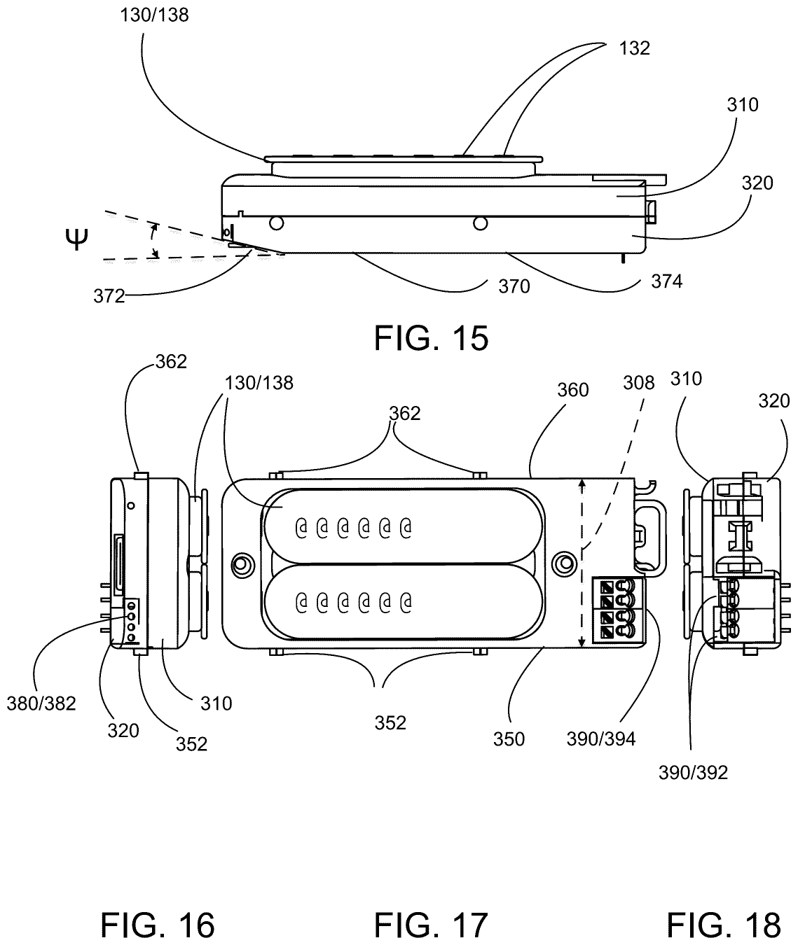

The bottom side (370) of the bottom piece (320) has a front portion (372) and a back portion (374). The front portion (372) of the bottom side (370) of the bottom piece (320) lies at an angle Ψ (psi) relative to the back portion (374) of the bottom side (370) of the bottom piece (320). The angle Ψ of the front portion (372) of the bottom side (370) of the bottom piece (320) allows an insert (300) to fit into a means to slide an insert (235) at an angle, to slide, and to be seated into its corresponding cavity (210) without having to touch the guitar strings (140). FIG. 15 is a left side view of an insert (300), showing the front side (330) of the insert (300) at an angle Ψ (psi) relative to the bottom side (370).

The angle Ψ of the front portion (372) of the bottom side (370) of the bottom piece (320) is less than ninety (90) degrees. The angle Y′ is preferably less than forty five (45) degrees. A range between ten (10) and forty (40) degrees provides for optimal conditions for an insert (300) to be seated with the least amount of effort into the corresponding cavity (210).

The left side (350) of the bottom piece (320) of the insert (300) comprises two or more slide guides (352). The right side (360) of the bottom piece (320) of the insert (300) comprises two or more slide guides (362). FIG. 17 is a top view of an insert (300), showing two slide guides (352) attached to the left side (350) of the bottom piece (320) of the insert (300) and two slide guides (362) attached to the right side (360) of the bottom piece (320) of the insert (300). To seat the insert (300) into the corresponding cavity (210), the left slide guides (352) and the right slide guides (362) are inserted into the corresponding means to slide an insert (235). The means to slide an insert (235) guides the right slide guides (362) and the right slide guides (352) of the inserts (300) into the corresponding cavity (210) so that the inserts (300) seat into the cavities (210).

The plurality of pin connectors (380) is operatively and electronically connected to the corresponding wire connectors (390). The plurality of pin connectors (380) of the insert (300) is located on the bottom piece (320) so that the plurality of pin connectors (380) operatively and electronically connects to the corresponding electronic target (234) on the back side panel (230) when the insert (300) is seated within the cavity (210). The pin connector (380) may be configured as a spring piston connector (382) so that the pin connector (380) retract inwards—as a piston—once the pin connectors (380) meet resistance from the electronic targets (234). This allows for electrical connection “play” as the insert (300) is slid into the cavity (210).

### 4 Pickguard Assembly (400)

The pickguard assembly (400) secures the guitar sound controls that change the guitar sound characteristics. The pickguard assembly (400) comprises a pickguard (145), one or more pre-wired volume controls (430), one or more pre-wired tone controls (440), one or more pre-wired selector switches (450), and wiring (420).

The various controls—one or more pre-wired volume controls (430), one or more pre-wired tone controls (440), and one or more pre-wired selector switches (450)—are attached to the pickguard (145).

The housing (410) contains the wiring (420) of the pickguard assembly (400). The wiring (420) operatively connects the various controls—one or more pre-wired volume controls (430), one or more pre-wired tone controls (440), and one or more pre-wired selector switches (450)—to the wiring attachment block (280) of the chassis body (200). The pickguard assembly (400) covers the pickguard cavity portion (124).

### 5 Clarifying Comments

While the foregoing written description of the invention enables a person having ordinary skill in the art to make and use what is considered presently to be the best mode thereof, those of ordinary skill in the art will understand and appreciate the existence of variations, combinations, and equivalents of the specific embodiment, process, and examples herein. The invention should therefore not be limited by the above described embodiment, process, and examples, but by all embodiments and processes within the scope and spirit of the invention.

The inventions shown and described herein may be used to address one or more of such problems or other problems not set out herein and/or which are only understood or appreciated at a later time. The future may also bring to light currently unknown or unrecognized benefits which may be appreciated, or more fully appreciated, in association with the inventions shown and described herein. The desires and expected benefits explained herein are not admissions that others have recognized such prior needs, since invention and discovery are both inventive under the law and may relate to the inventions described herein.

I claim:

1. An electric guitar quick exchange pickup assembly that allows pickups to be quickly exchanged in an electric guitar, the pickup assembly comprising:
(a) a chassis body, the chassis body comprising:
(i) one or more cavities; where each cavity defines:
(1) a front side panel;
(2) a back side panel; the back side panel comprising an electronic target;
(3) a left side panel; the left side panel comprising a means to slide an insert;
(4) a right side panel, the left side panel comprising a means to slide an insert;
(5) a bottom panel;
(6) where the front side panel lies at an angle Θ (theta) relative to the back side panel,
(ii) a wiring harness assembly;
(iii) a wiring attachment block;
(iv) where the wiring harness assembly operatively connects the electronic targets of each cavity to the wiring attachment block,
(b) one or more inserts; each insert comprising:
(i) a top piece; the top piece comprising:
(1) a pickup aperture;
(2) a handle;
(3) a front side;
(4) wherein the handle is attached to the front side of the top piece,
(ii) a bottom piece; the bottom piece comprising:
(1) a front side;
(2) a back side;
(3) a left side; the left side comprising one or more slide guides;
(4) a right side; the right side comprising one or more slide guides;
(5) a bottom side; the bottom side comprising a front portion and a back portion;
(6) a plurality of wire connectors and
(7) a plurality of pin connectors;
(8) where the plurality of pin connectors is operatively connected to the one or more pairs of wire connectors,
(9) where the front portion of the bottom side of the bottom piece lies at an angle Ψ (psi) relative to the back portion of the bottom side of the bottom piece,
(c) where each insert is seated into a corresponding cavity of the chassis body by the corresponding means to slide an insert,
(d) where the chassis body is inserted into a guitar body cavity within the electric guitar.

2. The pickup assembly described in claim 1, the pickup assembly further comprising:
(a) a pickguard assembly, the pickguard assembly comprising;
(i) a pickguard;
(ii) one or more pre-wired volume controls;
(iii) one or more pre-wired tone controls;
(iv) one or more pre-wired selector switches; and
(v) wiring;
(b) where the wiring of the pickguard assembly connects the one or more pre-wired volume controls, the one or more pre-wired tone controls, and one or more pre-wired selector switches to the wiring attachment block of the chassis body,
(c) where the pickguard assembly is inserted into the guitar body cavity within the electric guitar.

3. The pickup assembly described in claim 1,
(a) where the chassis body comprises exactly a first side cavity, a middle cavity, and a second side cavity,
(i) where the first side cavity comprises a first width,
(ii) where the second side cavity comprises a second width,
(iii) where the middle cavity comprises a third width,
(iv) where the width of one of the cavities is different than the width of other two cavities,
(b) where the pickup assembly comprises exactly a first side insert, a middle insert, and a second side insert,
(i) where the first side insert comprises a first width,
(ii) where the second side insert comprises a second width,
(iii) where the middle insert comprises a third width,
(iv) where the width of one of the inserts is different than the other two inserts,

4. The pickup assembly described in claim 3,
(a) where the width of the middle cavity is larger than the width of first side cavity and the second side cavity,
(b) where the width of the middle insert is larger than the width of the first side insert and the second side insert.

5. The pickup assembly described in claim 1,
(a) where each means to slide a cavity comprises:
(i) a channel, the channel comprising one or more protrusions,
(ii) where the one or more protrusions partially block the channel so that the protrusions prevent the slide guides from sliding back out past the protrusions and prevent the movement of the insert.

6. The pickup assembly described in claim 1,
(a) where the back side panels of the chassis body form an integral block,
(b) where the integral block is removable from the rest of the chassis body,
(c) where the wiring harness assembly and the electronic targets attached to the integral block.

7. The pickup assembly described in claim 6,
(a) where the wiring attachment block is attached to the integral block.

8. The pickup assembly described in claim 6,
(a) wherein the chassis body further comprises a circuit board;
(b) where the back side panels of the chassis body form an integral block,
(c) where the circuit board is attached to the integral block,
(d) where the integral block is removable from the rest of the chassis body,
(e) where the wiring harness assembly and the electronic targets attached to the circuit board.

9. The pickup assembly described in claim 8,
(a) where the wiring attachment block is attached to the circuit board.

10. The pickup assembly described in claim 1,
(a) wherein the pin connectors of the bottom piece of each insert are configured as spring piston connectors.

11. The pickup assembly described in claim 4,
(a) wherein the pin connectors of the bottom piece of each insert are configured as spring piston connectors.

12. The pickup assembly described in claim 5,
(a) wherein the pin connectors of the bottom piece of each insert are configured as spring piston connectors.
